(19) United States
(12) Patent Application Publication
(10) Pub. No.: US 2025/0116639 A1
(43) Pub. Date: Apr. 10, 2025

(54) CHROMATOGRAM DECOMPOSITION AND CORRESPONDING CALIBRATION

(71) Applicant: Schlumberger Technology Corporation, Sugar Land, TX (US)

(72) Inventor: Can Evren Yarman, Paris (FR)

(21) Appl. No.: 18/906,529

(22) Filed: Oct. 4, 2024

(30) Foreign Application Priority Data
Oct. 4, 2023 (EP) 23306706.5

(51) Int. Cl. G01N 30/86; G01N 30/02

(52) U.S. Cl. CPC G01N 30/8665; G01N 30/8624; G01N 2030/025

(57) ABSTRACT

A method for calibrating a GC apparatus includes measuring first and second chromatograms of corresponding first and second calibration samples in which the first calibration sample includes a first gas and the second calibration sample includes first, second, and third gases. The first chromatogram is fit with a basis function derived from a mass balance equation to obtain a first modeled chromatogram. The second chromatogram is fit with first, second, and third affine transformed responses of the first modeled chromatogram to obtain a second modeled chromatogram. The second modeled chromatogram may be used to decompose a third chromatogram that is measured of an unknown gas sample and to estimate the composition thereof.

### CROSS REFERENCE TO RELATED APPLICATIONS

This application claims priority to and the benefit of European Patent Application No. 23306706.5, titled “Chromatogram Decomposition and Corresponding Calibration,” filed Oct. 4, 2023, the entire disclosure of which is hereby incorporated herein by reference.

### BACKGROUND

Gas chromatography (GC) is a widely used technique for separating and analyzing chemical compounds that can be vaporized, such as organic compounds. Common applications relate to the quantitative and/or qualitative analysis of food composition, natural products, food additives, flavor and aroma components such as essential oils, a variety of transformation products and contaminants, such as pesticides, fumigants, natural toxins, pharmaceuticals, packaging materials and environmental pollutants. GC techniques are also used to evaluate the composition of gases that are liberated during downhole drilling operations, for example, including methane (C1), ethane (C2), propane (C3), butane (C4), pentane (C5) and the like, as well as alkenes and other compounds. Such measurements may provide valuable information to a mud logger and may provide information about the maturity and nature of hydrocarbons in the reservoir, compartmentalization of intervals in the reservoir being drilled, and oil quality, as well as information regarding production zones, lithology changes, history of reservoir accumulation, seal effectiveness, and environmental impact of the drilling operation.

GC measurements are often used to separate and analyze the individual gases in a gas sample (e.g., the liberated gases obtained in a drilling operation). The measurement acquired from GC is referred to as a chromatogram. It may be represented as a univariate function of the detector response against retention time (or elution time) and may be approximated as a mixture of Gaussian functions (Gaussians) for large retention times. One way to characterize the individual gases in a gas sample is through decomposition of the chromatogram using a Gaussian mixture model (GMM). While commonly used, the GMM approximation is generally not sufficient to capture the non-symmetric nature of local maxima of the chromatogram as well as asymptotic temporal decaying behavior and can therefore result in composition errors. There is a need for improved chromatogram decomposition and calibration methods, particularly for use with gas samples liberated during downhole drilling operations.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a disclosed gas chromatography apparatus for estimating a composition of formation gas.

FIG. 2 depicts the example GC apparatus shown on FIG. 1.

FIG. 3A depicts a flow chart of one example method for calibrating a GC measurement apparatus.

FIG. 3B depicts a flow chart of one example method for estimating a composition of an unknown gas sample using GC.

FIG. 4A depicts an example chromatogram (solid) measured using a calibration gas sample including only C1 and its modeled approximation (dashed).

FIG. 4B depicts corresponding components of the C1 response {aₘg_{MBE}(t,θₘ)}ₘ₌₁⁴ for the modeled approximation depicted on FIG. 4A.

FIG. 5 depicts an example chromatogram measured using the calibration gas sample GB2 in Table 1. The individual Cx responses of the chromatogram decomposition are noted.

FIGS. 6A, 6B, 6C, and 6D (collectively FIG. 6) depict measured chromatograms (solid) and the estimated chromatogram decomposition of the individual gases (dashed and noted) for example gas samples GB3 (6A), GB4 (6B), GB5 (6C), and GB6 (6D).

FIGS. 7A-7G (collectively FIG. 7) depict plots of the estimated gas concentration using the optimal m* versus the known concentrations for each of gas samples GB1 (7A), GB2 (7B), GB3 (7C), GB4 (7D), GB5 (7E), GB6 (7F), and GB7 (7G).

FIG. 8 depicts the measured chromatogram (solid) for gas sample GB7 (as a hypothetical unknown sample) and the decomposed C1, C2, and C3 gas components (dashed and noted).

### DETAILED DESCRIPTION

Embodiments of this disclosure include methods and systems for chromatogram decomposition and calibration. In one example embodiment, a disclosed method for estimating a composition of an unknown gas sample including at least first, second, and third gases includes calibrating a gas chromatography (GC) apparatus using first and second calibration samples in which the first calibration sample includes the first gas and the second calibration sample includes the first, second, and third gases. First and second chromatograms are measured of the corresponding first and second calibration samples using the GC apparatus. The first chromatogram is fit with a basis function derived from a mass balance equation to obtain a first modeled chromatogram. The second chromatogram is fit with first, second, and third affine transformed responses of the first modeled chromatogram to obtain a second modeled chromatogram. A third chromatogram is measured of the unknown gas sample using the GC apparatus. The third chromatogram is decomposed into components corresponding to the first, second, and third gases using the second modeled chromatogram. Concentrations of the first, second, and third gases are estimated from the first, second, and third gas components of the decomposed third chromatogram.

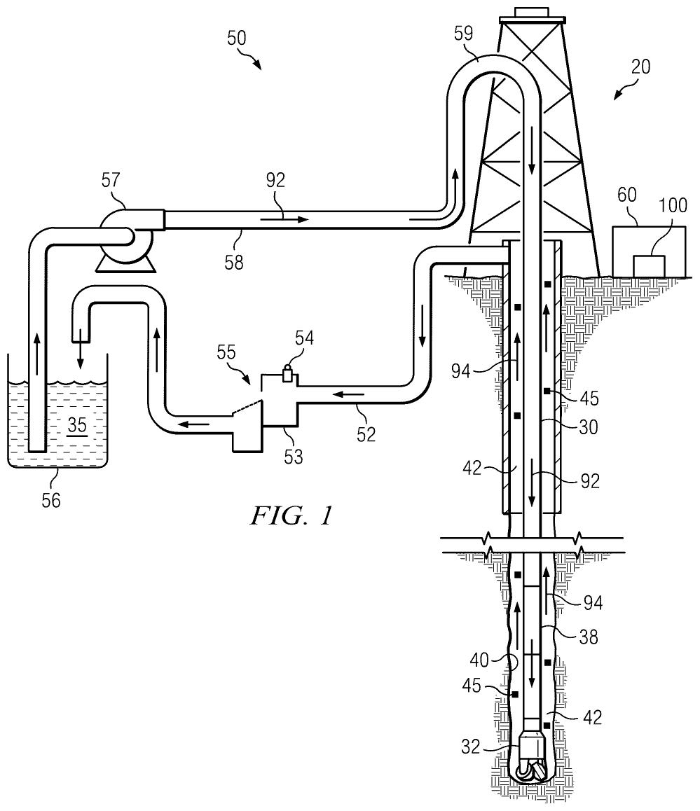

FIG. 1 depicts an example drilling rig 20 including a gas chromatography apparatus 100 for evaluating formation gas composition. The drilling rig 20 may be positioned over a subterranean formation (not shown). The rig 20 may include, for example, a derrick and a hoisting apparatus (also not shown) for raising and lowering a drill string 30, which, as shown, extends into wellbore 40 and includes, for example, a drill bit 32 and one or more downhole measurement tools 38 (e.g., a logging while drilling tool or a measurement while drilling tool) in a bottom hole assembly (BHA) above the bit 32. Suitable drilling systems, for example, including drilling, steering, logging, and other downhole tools are well known in the art.

Drilling rig 20 further includes a surface system 50 for controlling the flow of drilling fluid used on the rig (e.g., used in drilling the wellbore 40). In the example rig depicted, drilling fluid 35 is pumped downhole (as depicted at 92), for example, via a conventional mud pump 57. The drilling fluid 35 may be pumped, for example, through a standpipe 58 and mud hose 59 in route to the drill string 30. The drilling fluid 35 typically emerges from the drill string 30 at or near the drill bit 32 and creates an upward flow 94 of mud through the wellbore annulus 42 (the annular space between the drill string and the wellbore wall). The drilling fluid 35 then flows through a return conduit 52 to a mud pit system 56 where may be recirculated. It will be appreciated that the terms drilling fluid and mud are used synonymously herein.

The circulating drilling fluid 35 is intended to perform many functions during a drilling operation, one of which is to carrying drill cuttings 45 to the surface (in upward flow 94). The drill cuttings 45 are commonly removed from the returning mud via a shale shaker 55 (or other similar solids control equipment) in the return conduit (e.g., immediately upstream of the mud pits 56). Formation gases that are released during drilling may also be carried to the surface in the circulating drilling fluid. These gasses are commonly removed from the fluid, for example, via a degasser or gas trap 54 located in or near a header tank 53 that is immediately upstream of the shale shaker 55 in the example depiction. The drill cuttings 45 and gas are commonly examined at the surface to evaluate the formation layers though which the wellbore is drilled.

As is known to those of ordinary skill in the art, the formation gas may be released into the wellbore 40 via the drilling process (e.g., crushing the formation rock by the mechanical action of the drill bit) and may also migrate into the wellbore 40, for example, via fractures in the formation rock. Once in the wellbore, the formation gas may be transported to the surface via the drilling fluid (in the upwardly flowing fluid 94). The formation gas may be in solution in the drilling fluid and/or in the form of bubbles and may be sampled in the surface system, for example, via one or more drilling fluid degassers 54 and/or a head space gas probe. The disclosed embodiments are expressly not limited in regards to how the gas is sampled.

With further reference to FIG. 1, drilling rig 20 may further include a testing facility 60 (e.g., a laboratory trailer including one or more instruments suitable for making various measurements of drill cuttings and formation gases in the drilling fluid). In the depicted embodiment, the testing facility 60 includes a gas chromatography apparatus 100 (described in more detail below) configured to receive the formation gas and evaluate the formation gas composition. The testing facility 60 may, of course, include numerous other testing instruments known to those of ordinary skill in the industry. While the following embodiments are described with respect to drilling operations, it will be understood the that the disclosed embodiments are not so limited and may be applied to the use of GC in other chemical applications.

While GC is a powerful chemical analysis technique that enables many (most) chemical species to be separated at the detector, there remains room for improvement. In many gas samples, such as those including light hydrocarbons, certain species can have asymmetric responses in time as well as partially or fully overlapping elution times. This results in overlapping peaks in the chromatogram and tends to complicate quantitative determination of the gas composition. The disclosed embodiments may advantageously provide for improved calibration and decomposition of measured chromatograms and may therefore improve the accuracy the estimated gas composition.

It will of course be appreciated that while FIG. 1 depicts a land rig 20, that the disclosed embodiments are equally well suited for land rigs or offshore rigs. As is known to those of ordinary skill, offshore rigs commonly include a platform deployed atop a riser that extends from the sea floor to the surface. The drill string extends downward from the platform, through the riser, and into the wellbore through a blowout preventer (BOP) located on the sea floor. The disclosed embodiments are expressly not limited in these regards.

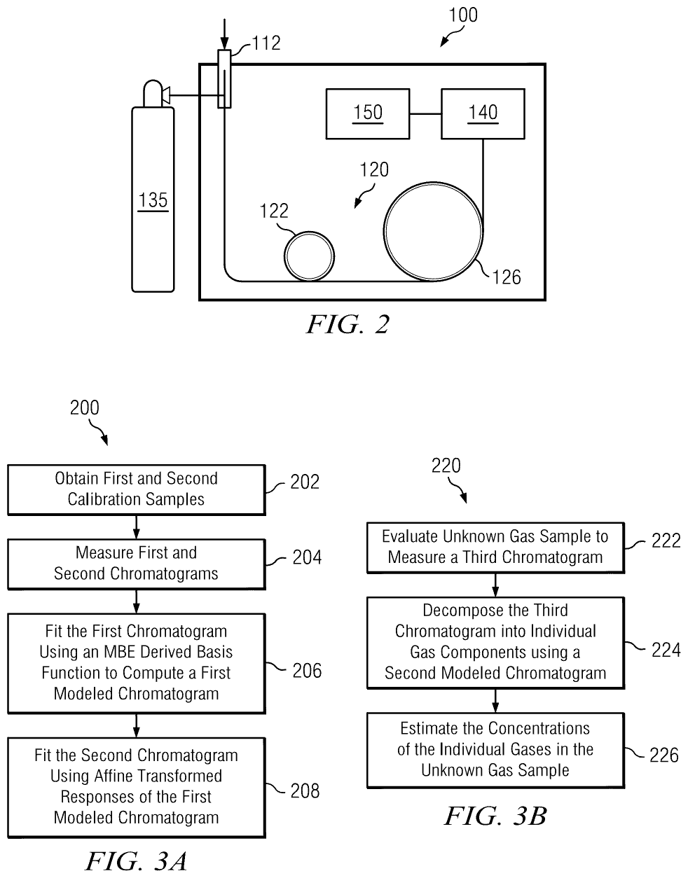

FIG. 2 depicts an example GC apparatus 100 including a gas sample injection port 112 configured to feed a gas sample into a column assembly 120 including an optional precut column 122 and a main GC column 126. The GC apparatus 100 further includes a carrier gas supply 135, such as a supply of compressed nitrogen, argon, helium, or air. An injected gas sample is mixed with the carrier gas and transported through the column assembly 120. The precut column 122 may be configured to remove heavier hydrocarbon compounds having a number of carbon atoms above a threshold, such as C6, C8, or C10 and above. The main column 126 generally includes a stationary phase and is intended to separate the various gas compounds in the gas sample such that they arrive at the detector 140 at distinct elution times, for example, such that C1 arrives before C2, which arrives before C3, and so on. The detector may include substantially any suitable GC detector, such as an FID detector, a TC detector, or a mass spectrometer. It will be understood that while example apparatus 100 includes a precut column 122, that the disclosed embodiments are not limited in this regard.

With continued reference to FIG. 2, GC apparatus 100 may further include an electronic controller 150 configured to control the detector 140 and a flow manifold (not depicted). So disposed, the controller may be configured to cause the GC apparatus to make GC measurements and calibrate the apparatus, for example, as described in more detail below with respect to FIGS. 3A and 3B. It will, of course, be appreciated that the controller may include computer hardware and software configured to cause the GC apparatus to perform these functions. The hardware may include one or more processors (e.g., microprocessors) which may be connected to one or more data storage devices (e.g., hard drives or solid state memory) and user interfaces. It will be further understood that the disclosed embodiments may include processor executable instructions stored in the data storage device. The disclosed embodiments are, of course, not limited to the use of or the configuration of any particular computer hardware and/or software.

FIG. 3A depicts a flow chart of one example method 200 for calibrating a GC measurement apparatus. The method includes obtaining at least first and second calibration samples at 202 in which the first calibration sample includes a known concentration of a first gas and the second calibration sample includes a known (the same or different) concentration of the first gas and known concentrations of at least first and second other gases (at least second and third gases). In advantageous embodiments, the first calibration sample may nominally include only the first gas (e.g., no other active gas components) or may include a negligible concentration of the at least first and second other gases. In certain embodiments, a negligible concentration is less than 10 ppm (e.g., less than 3 ppm or less than 1 ppm).

The first and second gas samples are evaluated with a GC apparatus (e.g., apparatus 100 in FIGS. 1 and 2) to measure corresponding first and second chromatograms at 204. The first chromatogram is fit using a basis function derived from a mass balance equation (MBE) at 206 to obtain a first modeled chromatogram. As described in more detail below the first modeled chromatogram may be defined by the basis function and a corresponding first set of calibration parameters. It will be appreciated that the basis function may be advantageously asymmetric with the retention time of the gas sample in the GC apparatus.

The second chromatogram is fit at 208 using at least first, second, and third affine transformed responses (corresponding to the first gas and the first and second other gases) of the first modeled chromatogram (the basis function and first calibration parameters used to fit the first chromatogram) to obtain a second modeled chromatogram. As described in more detail below, the second modeled chromatogram may be defined by the first modeled chromatogram and a second set of calibration parameters that characterize the responses of each of the gases in the second gas calibration sample.

FIG. 3B depicts a flow chart of one example method 220 for estimating a composition of an unknown gas sample using the GC apparatus calibrated in 200. The unknown gas sample is evaluated using the calibrated GC measurement apparatus to measure a chromatogram (a third chromatogram) at 222. The measured chromatogram is decomposed into individual gas components at 224 using the second modeled chromatogram obtained at 208 of method 200 to obtain a third modeled chromatogram. As described in more detail below, the decomposition may include adjusting the amplitudes of each of the individual gas components (peaks) in the second modeled chromatogram. The concentrations of each of the individual gases in the unknown gas sample may then be then estimated at 226 using the amplitudes of the individual decomposed gas components in the third chromatogram.

It will be understood that the material characterization problem in GC requires finding a decomposition \tilde{ƒ}(t) of a given chromatogram ƒ(t) for positive times t as a super position of a predefined basis g (t,θₘ) that is parameterized by θₘ, for example, as follows:

$$f ( t ) \approx \tilde{f} ( t ) = {\sum }_{m = 1}^{M} {a}_{m} g ( t , {θ}_{m} ) + {a}_{0} + B L ( t )$$

where aₘ represents a positive peak amplitude for m=0, 1, . . . , M and BL(t) represents an approximate baseline. For GC measurements it is assumed that ƒ(t), BL(t), and g(t,θₘ) are non-negative functions. The baseline BL(t) is GC system specific and can be measured when no sample is present in the system. For the sake of simplicity, it can be assumed that the baseline may be approximated by a constant, whose effects can be absorbed in do, and consider decomposition of a chromatogram in the following form:

$$f ( t ) \approx \tilde{f} ( t ) = {\sum }_{m = 1}^{M} {a}_{m} g ( t , {θ}_{m} ) + {a}_{0} \qquad ( 1 )$$

In the disclosed embodiments, g(t,θₘ) is a basis function that may be advantageously asymmetric with respect to elution time t and is derived from the solution of a mass balance equation (MBE). In one example embodiment, g(t,θₘ) may be of the following form:

$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t ) \qquad ( 2 )$$

where H(t) is the Heaviside step function which is equal to zero for t≤0 and one for t>0 and θₘ=(tₘ,sₘ,pₘ), where tₘ represents the retention time of a gas compound in a GC column or the GC apparatus, sₘ represents a spatial diffusion (or dispersion) coefficient that may be inversely related to the GC column length, and 1≤pₘ≤3 and represents a decay rate in time. The following discussion lists some properties of g_{MBE}(t,θₘ) that may be useful for numerical implementation of certain ones of the disclosed embodiments.

The maxima tₘ^{*} of g_{MBE}(t,θₘ) may satisfy:

$${{d}_{t} ( {g}_{M B E} ( t , {θ}_{m} ) ) \vert}_{t = {t}_{m}^{*}} = 0$$

Equivalently:

$${t}_{m}^{* 2} + {p}_{m} {s}_{m} {t}_{m}^{*} - {t}_{m}^{2} = 0$$

since

$$\begin{matrix}{d}_{t} g ( t , {θ}_{m} ) = {d}_{t} [ {t}^{- {p}_{m} / 2} exp ( - \frac{{( t - {t}_{m} )}^{2}}{2 {s}_{m} t} ) H ( t ) ] \\ = - {t}^{- ( \frac{{p}_{m}}{2} + 2 )} \frac{( {p}_{m} {s}_{m} t + {t}^{2} - {t}_{m}^{2} )}{2 {s}_{m}} exp ( \frac{- {( t - {t}_{m} )}^{2}}{2 {s}_{m} t} ) H ( t )\end{matrix}$$

Considering the positive root of the quadratic equation yields:

$${t}_{m}^{*} = \frac{\sqrt{{( {p}_{m} {s}_{m} )}^{2} + 4 {t}_{m}^{2}} - {p}_{m} {s}_{m}}{2}$$

Conversely, given the maxima tₘ^{*}, and pₘ, sₘ, one can compute tₘ by

$${t}_{m} = \sqrt{{t}_{m}^{* 2} + {p}_{m} {s}_{m} {t}_{m}^{*}}$$

Note that tₘ is associated with the retention time and may be later than or equal to the maxima location tₘ^{*}, i.e., tₘ≥tₘ^{*}. If tₘ^{*}>>pₘsₘ>0, then tₘ^{*}≈tₘ.

The basis function g_{MBE}(t,θₘ) may also be dilated with respect to time t with a dilation factor a.

$$\begin{matrix}{g}_{MBE} ( \frac{t}{a} , {θ}_{m} ) = {( \frac{t}{a} )}^{- \frac{{p}_{m}}{2}} exp ( \frac{- {( \frac{t}{a} - {t}_{m} )}^{2}}{\frac{2 {s}_{m} t}{a}} ) H ( \frac{t}{a} ) \\ = {a}^{\frac{{p}_{m}}{2}} {g}_{MBE} ( t , {γ}_{m} )\end{matrix}$$

where θₘ is as defined above and γₘ=(atₘ,asₘ,apₘ), which may be useful during implementation when time t requires rescaling.

The logarithm of g_{MBE}(t,θₘ) is as follows:

$$log g ( t , {θ}_{m} ) = - ( \frac{{p}_{m}}{2} log t + \frac{{( t - {t}_{m} )}^{2}}{2 {s}_{m} t} ) H ( t )$$

Since

$$\begin{matrix}{d}_{t} [ log g ( t , {θ}_{m} ) ] = - ( \frac{{p}_{m}}{2 t} + \frac{2 ( t - {t}_{m} )}{2 {s}_{m} t} - \frac{{( t - {t}_{m} )}^{2}}{2 {s}_{m} {t}^{2}} ) H ( t ) \\ = - ( \frac{1}{2 {s}_{m}} + \frac{{p}_{m} {s}_{m}}{2 {s}_{m} t} - \frac{{t}_{m}^{2}}{2 {s}_{m} {t}^{2}} ) H ( t )\end{matrix}$$

the maxima tₘ^{*} may be obtained by setting the foregoing to zero and solving for tₘ.

The integral of g_{MBE}(t,θₘ) for pₘ=1 may be obtained using the identity:

$$\int {t}^{- 1 / 2} exp ( - \frac{{( t - {t}_{m} )}^{2}}{2 {s}_{m} t} ) dt = \sqrt{\frac{π}{2} {s}_{m}} ( erf ( \frac{t - {t}_{m}}{\sqrt{2 {s}_{m} t}} ) + {e}_{{m}^{{s}_{m}^{- 1}}}^{2 t} erf ( \frac{t - {t}_{m}}{\sqrt{2 {s}_{m} t}} ) - {e}_{{m}^{{s}_{m}^{- 1}}}^{2 t} + 1 )$$

such that:

$$\begin{matrix}{\int }_{- ∞}^{∞} {g}_{MBE} ( t , {θ}_{m} ) dt = {\int }_{0}^{∞} {g}_{MBE} ( t , {θ}_{m} ) dt \\ = {\int }_{0}^{∞} {t}^{- 1 / 2} exp ( - \frac{{( t - {t}_{m} )}^{2}}{2 {s}_{m} t} ) dt \\ = \sqrt{2 π {s}_{m}}\end{matrix}$$

The integral of g_{MBE}(t,θₘ) for pₘ=3 may be obtained using a similar identity:

$$\int {t}^{- 3 / 2} exp ( - \frac{{( t - {t}_{m} )}^{2}}{2 {s}_{m} t} ) dt = \frac{1}{{t}_{m}} \sqrt{\frac{π}{2} {s}_{m}} ( erf ( \frac{t - {t}_{m}}{\sqrt{2 {s}_{m} t}} ) - {e}_{{m}^{{s}_{m}^{- 1}}}^{2 t} erf ( \frac{t - {t}_{m}}{\sqrt{2 {s}_{m} t}} ) + {e}_{{m}^{{s}_{m}^{- 1}}}^{2 t} - 1 ) + constant$$

such that

$$\begin{matrix}{\int }_{- ∞}^{∞} {g}_{MBE} ( t , {θ}_{m} ) dt = {\int }_{0}^{∞} {g}_{MBE} ( t , {θ}_{m} ) dt \\ = {\int }_{0}^{∞} {t}^{- 3 / 2} exp ( - \frac{{( t - {t}_{m} )}^{2}}{2 {s}_{m} t} ) dt \\ = \frac{\sqrt{2 π {s}_{m}}}{{t}_{m}}\end{matrix}$$

It will be appreciated that there isn't a unique solution to the decomposition problem expressed in Eqs. (1) and (2), particularly when evaluating a chromatogram including a combination of gases whose responses partially or fully overlap. As described in more detail below, a satisfactory solution may require additional constraints that may enable interpretation of the underlying physical and operational phenomenon associated with the gas samples of interest and the GC system. One way to achieve such a solution is to measure the responses of the GC system with respect to each of the gases of interest, for example, using calibration samples having known concentrations of the individual gases of interest. Once individual responses are decomposed, the chromatogram may be represented as a combination of these responses. In this case, M represents the number of gases and g(t,θₘ) denotes an approximation of the response of the GC system to the m^{th} gas. However, one drawback with this approach is that it can require a large number of calibration samples corresponding to the number of expected gases.

Alternative constraints may be considered when there is limited access to calibration samples including only a single gas. For example, in certain embodiments, single gas calibration samples may not be readily available for each of the expected gases in a gas sample. In such instances a calibration may be achieved using calibration bottles including a mixture of the gases. The individual gas responses may be obtained by a linear combination of the corresponding chromatograms, assuming that the GC signal behaves linearly with respect to the gas concentration ranges of interest and the gas concentrations are linearly independent.

One aspect of the disclosed embodiments was the realization that in cases in which the gas concentrations are linearly dependent on one another, it may be further assumed that the response of the system to the particular gases of interest are an affine transformation of each other. Such an assumption may advantageously enable system calibration with a significant reduction in the number of calibration bottles needed and may further advantageously reduce the time required to calibrate the GC system. It will be appreciated that the term “affine transformation” is used herein in the standard mathematical sense of a being a geometric transformation or function that maps an affine space onto itself while preserving both the dimension of any affine subspaces and the ratios of the lengths of parallel line segments. In other words, the affine transformation preserves lines and parallelism but not necessarily Euclidean distances and angles.

Table 1 lists the composition of example gas bottles used in example implementations of the disclosed calibration methodology. The gas bottles GB1, GB2, GB3, GB4, GB5, GB6, and GB7 include mixtures of methane (C1), ethane (C2), propane (C3), isobutane (iC4), butane (nC4), isopentane (iC5), and pentane (nC5). The gas concentrations are listed in units of parts per million (ppm) (where 1 ppm is equal to 0.0001 percent).

TABLE 1

| Sample | C1 | C2 | C3 | iC4 | nC4 | iC5 | nC5 |
|---|---|---|---|---|---|---|---|
| GB1 | 300,000 | 0 | 0 | 0 | 0 | 0 | 0 |
| GB2 | 100,000 | 25,000 | 25,000 | 10,000 | 10,000 | 2,500 | 2,500 |
| GB3 | 50,000 | 12,500 | 12,500 | 8,500 | 8,500 | 2,000 | 2,000 |
| GB4 | 10,000 | 2,500 | 2,500 | 2,500 | 2,500 | 1,000 | 1,000 |
| GB5 | 1,000 | 250 | 250 | 250 | 250 | 250 | 250 |
| GB6 | 100 | 25 | 25 | 25 | 25 | 25 | 25 |
| GB7 | 7,500 | 25 | 25 | 0 | 0 | 0 | 0 |

In the example gas bottles in Table 1, the gas concentrations are linearly dependent. Specifically, the concentrations of C2 and C3, iC4 and nC4, and iC5 and nC5 are pairwise correlated. In this example, there are seven gas bottles and seven gases of interest, however, isolation of the individual gas responses using a linear inversion is not possible except for C1. In the example embodiments that follow, gas bottles GB1 and GB2 are used to calibrate the GC system. Gas bottles GB3, GB4, GB5, GB6, and GB7 are used to test the calibration.

In the disclosed embodiments, it is assumed that a measured chromatogram may be expressed as a linear combination of individual gas responses, for example, as follows:

$$f ( t ) = {\sum }_{C x ∈ G} {a}_{Cx} {g}_{Cx} ( t - Δ t ) + {a}_{0} \qquad ( 3 )$$

where g_{Cx}(t) represents the response of the GC system to gas Cx, Δt represents an unaccountable time delay during injection the gas sample into the GC apparatus, and G represents the set of gases in the calibration, for example, including C1, C2, C3, iC4, nC4, iC5, and nC5.

With reference again to FIGS. 3A and 3B, the C1 response is approximated at 206 using a first chromatogram measured using the first gas sample (e.g., a calibration sample including only C1 such as GB1 in Table 1). A second chromatogram is measured using a second gas sample (e.g., GB2) that contains each of the other gases of interest. The responses of the other gases are modeled at 208 as affine transformed versions of the modeled C1. It will be appreciated that gas samples GB3, GB4, GB5, or GB6 in Table 1 may alternatively be used in 208. Upon modeling the individual gas responses and determining the system calibration (as described in more detail below), a chromatogram of an unknown gas sample may be decomposed at 224 as a linear combination of the individual gas responses modeled in 206 and 208 of method 200. In the following disclosure, an example calibration is described in which calibration samples GB1 and GB2 are utilized are used to calibrate the GC apparatus. The calibration is then tested using gas samples GB3, GB4, GB5, GB6, and GB7 (as though they were unknown samples). The disclosed embodiments are, of course, not limited to the use of only first and second calibration samples to calibrate a GC system.

With further reference to element 206 of FIG. 3A, the C1 response g_{C1}(t) of the GC apparatus may be approximated or modeled by \tilde{g}_{C1}(t) to obtain the first calibration parameters, for example, as follows:

$${g}_{C 1} ( t ) \approx {\tilde{g}}_{C 1} ( t ) = {\sum }_{m = 1}^{M} {a}_{m} {g}_{MBE} ( t , {θ}_{m} ) \qquad ( 4 )$$

where aₘ represents an amplitude and g_{MBE}(t,θₘ) is as defined above and represents an MBE derived basis function including model parameters θₘ=(tₘ,sₘ,pₘ). In this particular example, the first calibration parameters are aₘ, tₘ, sₘ and pₘ such that number of first calibration parameters is equal to 4M.

With continued reference to Eq. (4), the C1 response may be modeled, for example, by fitting the measured histogram ƒ(t) (the measured chromatogram) for calibration sample GB1 via minimization of a cost function/[ϵ₁]=(Lₚ[ϵ₁])^{p} for some p≥1. Here Lₚ is the p-norm of the error ϵ₁(t)=ƒ(t)−[\tilde{g}_{C1}(t)+a₀] that is defined by Lₚ[ϵ₁]=(∫|ϵ₁(t)|^{p}dt)^{p}^{^{−1}}. Denoting the combination of linear {aₘ}ₘ₌₁^{M} and non-linear {θₘ}ₘ₌₁^{M} parameters by Θ={aₘ,θₘ}ₘ₌₁^{M}, the optimal Θ corresponding to the approximation \tilde{g}_{C1}(t) is given by Θ₁ that satisfy the following:

$$( {a}_{0}^{*} , {θ}_{1} ) = arg {min}_{( {a}_{0} , θ )} J [ {ϵ}_{1} ] = arg {min}_{( {a}_{0} , θ )} [ \int {\vert {f}_{C 1} ( t ) - ( {\sum }_{m = 1}^{M} {a}_{m} {g}_{MBE} ( t , {θ}_{m} ) + {a}_{0} ) \vert}^{p} dt ]$$

where Θ₁ represent the first model parameters. Note that the integral with respect to t should be considered in a general sense where the integration could be performed over a combination of single, multiple, infinite, finite, connected, disjoint, continuous and discontinuous domains.

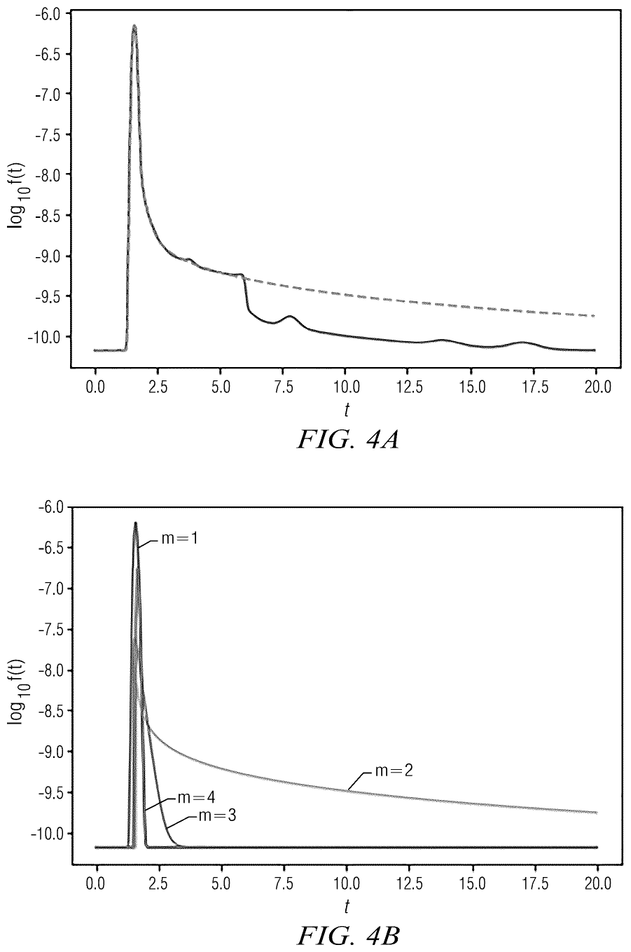

FIG. 4A depicts an example measured chromatogram (solid) for calibration sample GB1 and its modeled approximation (dashed). Note the good fit provided by the model up to about 5.5 seconds. FIG. 4B depicts the corresponding components of the C1 response {aₘg_{MBE}(t,θₘ)}ₘ₌₁⁴ for the modeled approximation depicted on FIG. 4A in which m=1, 2, 3 and 4 are indicated. In this example, the first calibration parameters include 16 model parameters (4·4). Note that for p=1, the approximate C1 response may be tailored towards the first 5.5 seconds of the chromatogram to avoid the abrupt amplitude drop that is observed. The remaining calibration is based on this approximate C1 response.

With further reference to element 208 of FIG. 3A, assuming that the response g_{Cx}(t) for Cx∈G is an affine transformed version of g_{C1}(t) yields the following:

$${g}_{Cx} ( t ) \approx {\tilde{g}}_{Cx} ( t ) = {\tilde{g}}_{C 1} ( \frac{t - {t}_{Cx}}{{s}_{Cx}} ) , Cx ∈ G \qquad ( 5 )$$

where the affine transformations are characterized by model parameters t_{Cx} and s_{Cx} that represent the individual Cx retention times and spatial diffusion coefficients.

Following Eq. (3), the measured second chromatogram ƒ₂(t) may be modeled as \tilde{ƒ}₂(t), for example, as follows:

$${f}_{2} ( t ) \approx {\tilde{f}}_{2} ( t ) = {\sum }_{Cx ∈ G} {a}_{Cx} {\tilde{g}}_{Cx} ( t ) + {a}_{0} = {\sum }_{Cx ∈ G} {a}_{Cx} {\tilde{g}}_{C 1} ( \frac{t - {t}_{Cx}}{{s}_{Cx}} ) + {a}_{0} \qquad ( 6 )$$

where a_{Cx} represent the amplitudes of responses \tilde{g}_{Cx}(t) of the individual Cx component gases and a₀ represents a detector response shift. Let the model parameters Θ={a_{Cx},t_{Cx},s_{Cx}}_{Cx∈G}. The optimal Θ corresponding to the modeled gas responses {\tilde{g}_{Cx}(t)}_{Cx∈G} may be given by Θ_{G} that satisfy the following:

$$( {a}_{0}^{*} , {Θ}_{G} ) = arg {min}_{( {a}_{0} , θ )} [ \int {\vert {f}_{2} ( t ) - ( {\sum }_{Cx ∈ G} {a}_{Cx} {\tilde{g}}_{C 1} ( \frac{t - {t}_{Cx}}{{s}_{Cx}} ) + {a}_{0} ) \vert}^{p} dt ]$$

where Θ_{G} represent the second model parameters. As described in more detail below, system calibration may further include generating correlations (such as linear correlations) between the amplitudes a_{Cx} and the concentrations of gases Cx. It has been found that the amplitudes advantageously vary linearly with gas concentration.

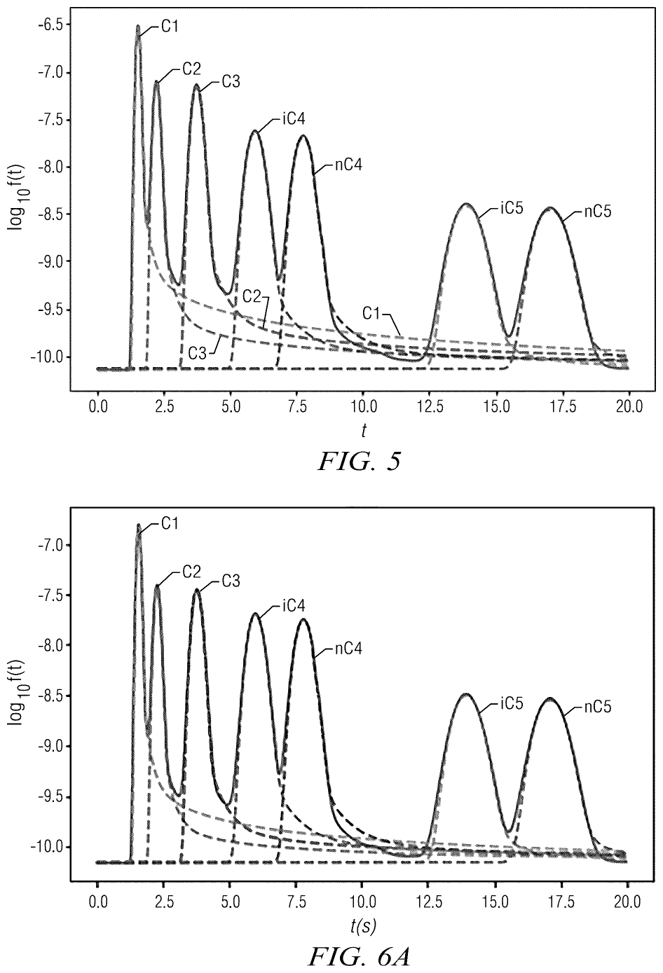

FIG. 5 depicts an example measured chromatogram using the calibration sample GB2 in Table 1. The measured chromatogram is solid and the modeled Cx gas responses for p=1 are dashed. In this example, the second calibration parameters include 21 model parameters (three parameters for each of the seven gases). Note that the sum of the dashed Cx responses provides a good fit of the measured chromatogram, particularly for the asymmetric C1, C2, and C3 peaks. The individual Cx responses are noted in the figure.

With further reference to element 224 of FIG. 3B, a chromatogram of an unknown gas sample (e.g., a third chromatogram) ƒ₃(t) may be modeled \tilde{ƒ}₃(t) by decomposition into the individual gas responses (or components) obtained during the calibration in 206 and 208 (e.g., obtained as described above). For example:

$${f}_{3} ( t ) \approx {\tilde{f}}_{3} ( t ) = {\sum }_{Cx ∈ G} {f}_{Cx} {\tilde{g}}_{Cx} ( t - Δ t ) + {f}_{0} \qquad ( 7 )$$

where \tilde{g}_{Cx} represent the responses of the individual component gases Cx, Δt represents a time shift and ƒ₀ represents a detector response shift that translate the gas responses together (as a unit), and ƒ_{Cx} represent the amplitudes of the individual gas responses in the modeled chromatogram \tilde{ƒ}₃(t). The decomposition may include optimizing {ƒ_{Cx}}_{Cx∈G}, ƒ₀, and Δt, for example, as follows:

$$( {f}_{0}^{*} , {\{ {f}_{Cx}^{*} \}}_{Cx ∈ G} , Δ {t}^{*} ) = arg {min}_{( {f}_{0} , {\{ {f}_{Cx} \}}_{Cx ∈ G} , Δ t )} [ \int {\vert {f}_{3} ( t ) - ( {\sum }_{Cx ∈ G} {f}_{Cx} {\tilde{g}}_{Cx} ( t - Δ t ) + {f}_{0} ) \vert}^{p} dt ]$$

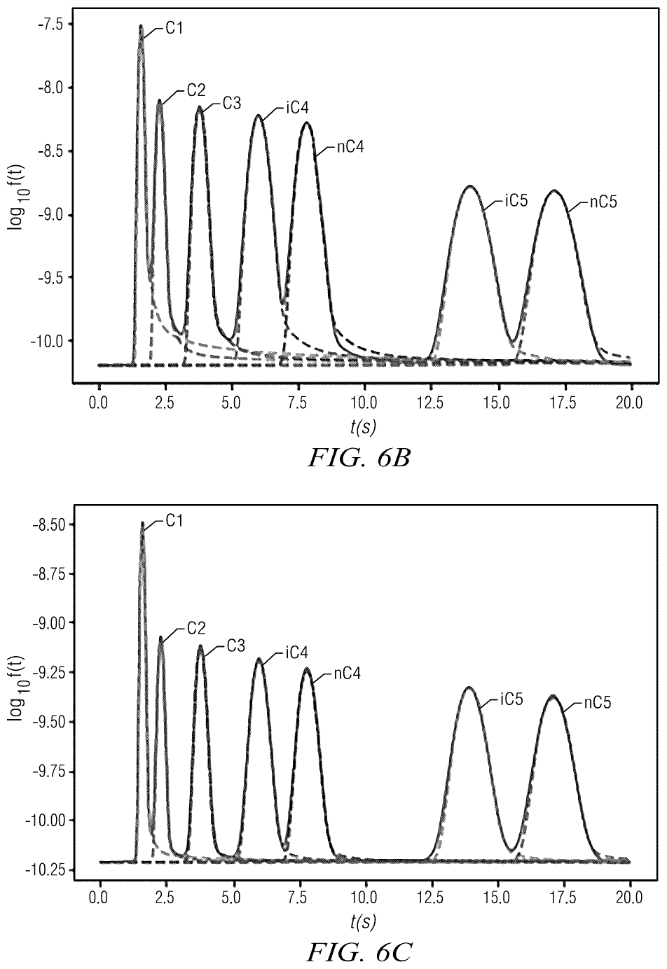

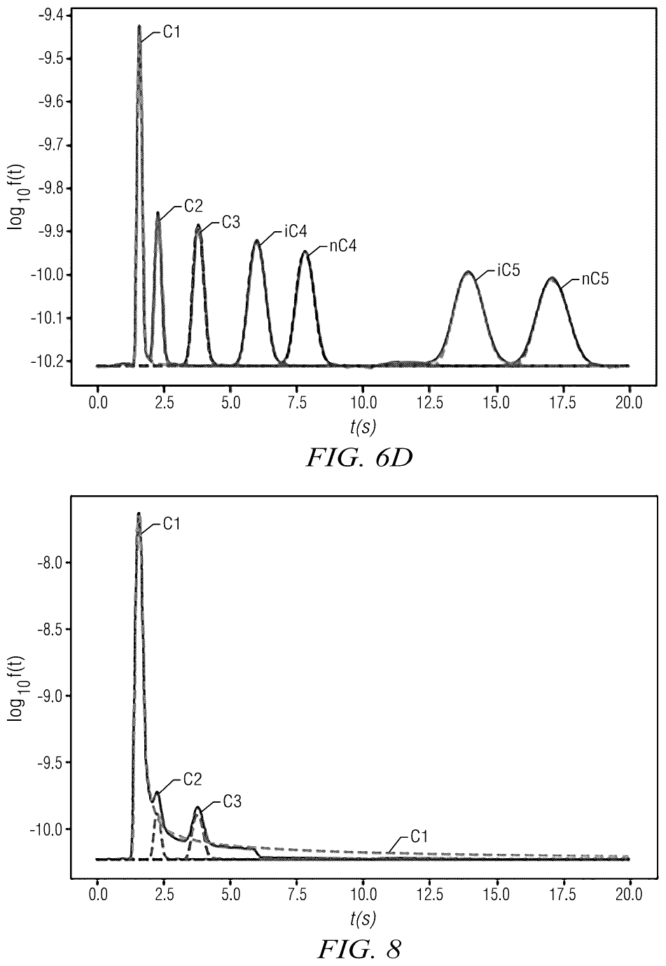

FIGS. 6A, 6B, 6C, and 6D (collectively FIG. 6) depict measured chromatograms (solid) and modeled decomposition responses of the individual gases (dashed) for gas samples GB3 (6A), GB4 (6B), GB5 (6C), and GB6 (6D). In these examples, the GB3, GB4, GB5, and GB6 gas samples were treated as unknowns. Note that the sum of the dashed Cx responses provides a good fit of each the chromatograms for all peaks and over several orders of magnitude of Cx concentrations.

With further reference to element 226 of FIG. 3B, the concentrations of the individual gases in a gas sample may be estimated via calibration curves that may be obtained, for example, by constructing a relationship between the injected gas samples with known composition and the amplitudes of the individual gas responses in the modeled chromatogram \tilde{ƒ}₃(t). Assuming that the GC signal is proportional to the quantity of gas reaching the detector, it is expected that the integral of the components of a decomposed chromatogram, or equivalently the decomposition coefficients, may be linearly proportional to the amount of corresponding gas in the GC system.

It will be appreciated that the disclosed embodiments are not limited to embodiments in which the calibration samples include each and every gas in the unknown sample. For example, the in applications in which there is a gas or gases (or gas components) that are not within the calibration, the additional gas component(s) may be detected (and optionally quantified) as contamination that falls outside the estimated response functions.

Let ƒ_{GB}(t) be the chromatogram obtained by injecting a gas sample GB into the GC and x_{Cx}[ƒ_{GB}] be the concentration of the gas Cx in gas sample GB. Given the approximate responses \tilde{g}_{Cx}(t), let

$${f}_{GB} ( t ) \approx {\sum }_{Cx ∈ G} {a}_{Cx}^{*} [ {f}_{GB} ] {\tilde{g}}_{Cx} ( t - Δ {t}_{GB} ) + {a}_{0}^{*}$$

be the decomposition of the chromatogram obtained from GB. The linearity may be verified by computing the Pearson correlation coefficient between the concentrations in the calibration samples x_{Cx}[ƒ_{GB}] and the coefficients (peak amplitudes) a_{Cx}^{*}[ƒ_{GB}]. The Pearson correlation coefficient (PCC) may be computed, for example, as follows:

$${PCC}_{Cx} = 〈 {\hat{x}}_{Cx} , {Cx}_{} 〉$$

$$\text{where:}$$

$$〈 {\hat{x}}_{Cx} , {Cx}_{} 〉 = {\sum }_{GB} {\hat{x}}_{Cx} [ {f}_{GB} ] {Cx}_{} [ {f}_{GB} ]$$

$$with$$

$${\hat{x}}_{Cx} [ {f}_{GB} ] = ( {x}_{Cx} [ {f}_{GB} ] - {μ}_{x , Cx} ) {σ}_{x , Cx}^{- 1}$$

$${μ}_{x , Cx} = ( {\sum }_{GB} {x}_{Cx} [ {f}_{GB} ] ) {( {\sum }_{GB} 1 )}^{- 1}$$

$${σ}_{x , Cx}^{2} = ( {\sum }_{GB} \vert {x}_{Cx} [ {f}_{GB} ] - {μ}_{x , Cx} {\vert}^{2} ) {( {\sum }_{GB} 1 )}^{- 1}$$

$${Cx}_{} [ {f}_{GB} ] = ( {a}_{Cx}^{*} [ {f}_{GB} ] - {μ}_{{a}^{*} , Cx} ) {( {μ}_{{a}^{*} , Cx} )}^{- 1}$$

$${μ}_{{a}^{*} , Cx} = ( {\sum }_{GB} {a}_{Cx}^{*} [ {f}_{CB} ] ) {( {\sum }_{GB} 1 )}^{- 1}$$

$${σ}_{{a}^{*} , Cx}^{2} = ( {\sum }_{GB} {\vert {a}_{Cx}^{*} [ {f}_{G B} ] - {μ}_{{a}^{*} , Cx} \vert}^{2} ) {( {\sum }_{GB} 1 )}^{- 1}$$

Table 2 lists the Pearson correlation coefficients between the concentrations x_{Cx} of the calibration samples and the amplitudes a_{Cx}^{*} of the corresponding chromatogram decompositions (obtained from chromatograms shown on FIG. 6). The listed correlation coefficients are all greater than 0.997 indicating a high degree of linearity between the decomposition amplitudes and the individual gas concentration. It will therefore be appreciated that the gas concentrations may be obtained directly from the individual peak amplitudes (via direct linear correlation).

TABLE 2

| C1 | C2 | C3 | iC4 | nC4 | iC5 | nC5 |
|---|---|---|---|---|---|---|
| 0.997189 | 0.999997 | 0.999983 | 0.999994 | 0.999996 | 0.999830 | 0.999866 |

Given the decomposition of a chromatogram ƒ(t) corresponding to a gas sample of interest:

$$f ( t ) \approx \tilde{f} ( t ) = {\sum }_{Cx ∈ G} {f}_{Cx}^{*} {\tilde{g}}_{Cx} ( t - Δ {t}^{*} ) + {f}_{0}^{*}$$

the linear calibration curve indicates that the estimated concentration x_{Cx}^{*}[ƒ] and coefficients of the decomposition a_{Cx}^{*}[ƒ] are related, for example, as follows:

$${x}_{Cx}^{*} [ f ] = {m}_{Cx} {a}_{Cx}^{*} [ f ] \qquad ( 8 )$$

for some constant m, which may be selected or computed to optimally match the gas concentrations of the calibration sample(s). When only a single calibration sample is used, the optimal m_{Cx} is given exactly as m_{Cx}^{*}=x_{Cx}[ƒ_{CB}](a_{Cx}^{*}[ƒ_{GB}])⁻¹. When multiple calibration samples are used, one example way to compute the optimal m_{Cx} is to minimize the normalized mean square error, for example, as follows:

$${m}_{Cx}^{*} = arg {min}_{( m )} {\sum }_{G B} {\vert 1 - m \frac{{a}_{Cx}^{*} [ {f}_{G B} ]}{{x}_{Cx} [ {f}_{G B} ]} \vert}^{2} = 〈 \frac{{a}_{Cx}^{*} [ {f}_{G B} ]}{{x}_{Cx} [ {f}_{G B} ]} , 1 〉 {〈 \frac{{a}_{Cx}^{*} [ {f}_{G B} ]}{{x}_{Cx} [ {f}_{G B} ]} , \frac{{a}_{Cx}^{*} [ {f}_{G B} ]}{{x}_{Cx} [ {f}_{G B} ]} 〉}^{- 1} \qquad ( 9 )$$

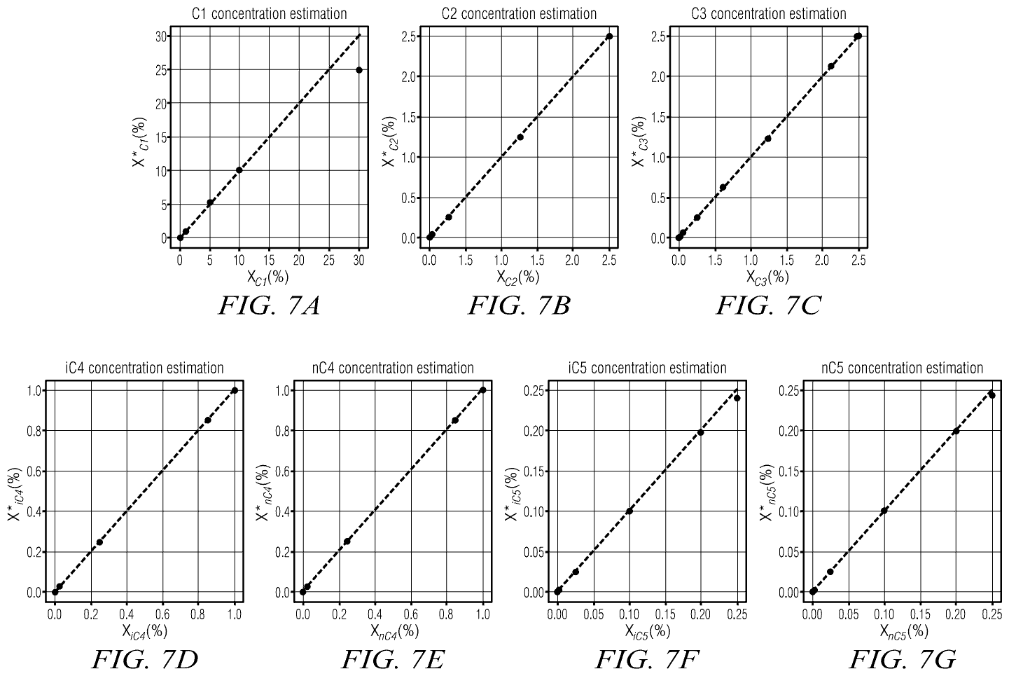

for x_{Cx}[ƒ_{CB}]>0. Note that Eqs. (8) and (9) advantageously ensure that the estimated concentration is zero when the amplitude is zero. Plots of estimated gas concentrations using the optimal m_{Cx}^{*}, versus the known concentrations in the calibration samples are presented in FIG. 7. Note the high degree of linearity as further indicated by the Pearson correlation coefficients given in Table 2.

A ratio test was used to test the sensitivity of the measurement and decomposition process by injecting calibration sample GB7 into the GC measurement apparatus. As indicated in Table 1, GB7 has high C1 to C2 and C1 to C3 concentration ratios (300:1). It is often desirable to detect low concentrations of C2 and C3 relative to C1 and to provide an estimate of corresponding concentrations within reasonable error bounds. Accurately detecting such low concentrations can be challenging when the peaks of the individual gases are temporally close to each other (have similar elution times) as with C1, C2, and C3. Moreover, it can be particularly challenging when the GC apparatus is adapted for making fast GC measurements, for example, including a shorter GC column or a faster carrier gas flow rate, etc.

FIG. 8 depicts the measured chromatogram (solid) for calibration sample GB7 (as a hypothetical unknown sample) and the decomposed C1, C2, and C3 components (dashed) computed as described above (using the calibration parameters obtained during the GC system calibration with calibration samples GB1 and GB2). Note the good fit provided by the decomposed C1, C2, and C3 components. Table 3 lists the actual x_{Cx}[ƒ_{CB7}] and estimated x_{Cx}^{*}[ƒ_{CB}] concentrations of C1, C2, and C3 as well as the C1/C2 and C1/C3 ratios. Note that the C1 and C3 concentrations were estimated within 1 percent and the C2 concentration within 5 percent. This result is particularly encouraging, especially for C2, the peak of which is almost entirely obscured by the asymmetric tail of the C1 peak.

TABLE 3

| | C1 | C2 | C3 | C1/C2 | C1/C3 |
|---|---|---|---|---|---|
| x_{Cx} [f_{GB7}] | 7500.0 | 25.0 | 25.0 | 300.0 | 300.0 |
| x_{Cx}* [f_{GB}] | 7450.8 | 23.8 | 24.8 | 312.8 | 300.5 |

It will be understood that the present disclosure includes numerous embodiments. These embodiments include, but are not limited to, the following embodiments.

In a first embodiment, a method for estimating a composition of an unknown gas sample including at least first, second, and third gases includes calibrating a gas chromatography (GC) apparatus using first and second calibration samples in which the first calibration sample includes the first gas and the second calibration sample includes the first, second, and third gases, the calibrating comprising measuring first and second chromatograms of the corresponding first and second calibration samples using the GC apparatus; fitting the first chromatogram with a basis function derived from a mass balance equation to obtain a first modeled chromatogram; and fitting the second chromatogram with first, second, and third affine transformed responses of the first modeled chromatogram to obtain a second modeled chromatogram, the first, second, and third affine transformed responses corresponding to the first, second, and third gases; measuring a third chromatogram of the unknown gas sample using the GC apparatus; decomposing the third chromatogram into components corresponding to the first, second, and third gases using the second modeled chromatogram; and estimating concentrations of the first, second, and third gases from the first, second, and third gas components of the decomposed third chromatogram.

A second embodiment may include the first embodiment, wherein the basis function is asymmetric with respect to retention time.

A third embodiment may include any one of the first through second embodiments, wherein the first calibration sample comprises a negligible concentration of the second and third gases.

A fourth embodiment may include any one of the first through third embodiments, wherein the unknown gas sample comprises at least methane, ethane, propane, butane, and pentane.

A fifth embodiment may include any one of the first through fourth embodiments, wherein the first modeled chromatogram comprises a first set of calibration parameters including a retention time, a spatial diffusion coefficient, and a decay rate of the first gas in the GC apparatus; and the second modeled chromatogram comprises a second set of calibration parameters including a retention time and a spatial diffusion coefficient for each of the first, second, and third gases, and an amplitude for each of the first, second, and third affine transformed responses of the first modeled chromatogram.

A sixth embodiment may include the fifth embodiment, wherein the first chromatogram is fit using the following mathematical equation:

$${\tilde{g}}_{C 1} ( t ) = {\sum }_{m = 1}^{M} {a}_{m} {g}_{M B E} ( t , {θ}_{m} )$$

wherein \tilde{g}_{C1}(t) represents the first modeled chromatogram, aₘ represents an amplitude, and g_{MBE}(t,θₘ) represents the basis function, wherein:

$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t )$$

wherein H(t) represents the Heaviside step function and θₘ=(tₘ,sₘ,pₘ) in which tₘ represents the retention time of the first gas in the GC apparatus, sₘ represents the spatial diffusion coefficient of the first gas in the GC apparatus, and pₘ represents the decay rate of the first gas in the GC apparatus.

A seventh embodiment may include the sixth embodiment, wherein the second chromatogram is fit using the following mathematical equation:

$${\tilde{f}}_{2} ( t ) = {\sum }_{Cx ∈ G} {a}_{Cx} {\tilde{g}}_{C 1} ( \frac{t - {t}_{Cx}}{{s}_{Cx}} ) + {a}_{0}$$

wherein \tilde{ƒ}₂(t) represents the second modeled chromatogram, t_{Cx} and s_{Cx} represent the retention times and spatial diffusion coefficients of the first, second, and third gases Cx, and a_{Cx} represent the amplitudes of the first, second, and third affine transformed responses

$${\tilde{g}}_{C 1} ( \frac{t - {t}_{Cx}}{{s}_{Cx}} )$$

of the first modeled chromatogram.

An eighth embodiment may include any one of the first through seventh embodiments, wherein the concentrations of the first, second, and third gases are estimated from corresponding amplitudes of the first, second, and third gas components of the decomposed third chromatogram.

A ninth embodiment may include the eighth embodiment, wherein the third chromatogram is decomposed using the following mathematical equation:

$${\tilde{f}}_{3} ( t ) = {\sum }_{Cx ∈ G} {f}_{Cx} {\tilde{g}}_{Cx} ( t - Δ t ) + {f}_{0}$$

wherein ƒ₃(t) represents the decomposed third chromatogram, \tilde{g}_{Cx} represent responses of the first, second, and third gases Cx in the second modeled chromatogram, Δt represents a time shift, ƒ₀ represents a detector response shift, ƒ_{Cx} represent amplitudes of the first, second, and third gas components.

A tenth embodiment may include any one of the first through ninth embodiments, wherein the calibrating the gas chromatography (GC) apparatus further comprises generating first, second, and third linear correlations between corresponding amplitudes of the first, second, and third affine transformed responses of the first modeled chromatogram and concentrations of the first, second, and third gases.

In an eleventh embodiment, a system for estimating a composition of an unknown gas sample including at least first, second, and third gases comprises a gas chromatography (GC) apparatus including a sample injection port, a main column, and a GC detector; and a processor configured to fit a first chromatogram with a basis function derived from a mass balance equation to compute a first modeled chromatogram, the first chromatogram measured using a first calibration sample including the first gas; fit a second chromatogram with first, second, and third affine transformed responses of the first modeled chromatogram to compute a second modeled chromatogram, the second chromatogram measured using a second calibration sample including the first, second, and third gases, the first, second, and third affine transformed responses corresponding to the first, second, and third gases; decompose a third chromatogram into first, second, and third gas components using the second modeled chromatogram, the third chromatogram measured using the unknown gas sample; and estimate concentrations of the first, second, and third gases from the first, second, and third gas components of the decomposed third chromatogram.

A twelfth embodiment may include the eleventh embodiment, wherein the first chromatogram is fit using the following mathematical equation:

$${\tilde{g}}_{C 1} ( t ) = {\sum }_{m = 1}^{M} {a}_{m} {g}_{M B E} ( t , {θ}_{m} )$$

wherein \tilde{g}_{C1}(t) represents the first modeled chromatogram, aₘ represents an amplitude, and g_{MBE}(t,θₘ) represents the basis function, wherein:

$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t )$$

wherein H(t) represents the Heaviside step function and θₘ=(tₘ,sₘ,pₘ) in which tₘ represents the retention time of the first gas in the GC apparatus, sₘ represents the spatial diffusion coefficient of the first gas in the GC apparatus, and pₘ represents the decay rate of the first gas in the GC apparatus.

A thirteenth embodiment may include the twelfth embodiment, wherein the second chromatogram is fit using the following mathematical equation:

$${\tilde{f}}_{2} ( t ) = {\sum }_{Cx ∈ G} {a}_{Cx} {\tilde{g}}_{C 1} ( \frac{t - {t}_{Cx}}{{s}_{Cx}} ) + {a}_{0}$$

wherein \tilde{ƒ}₂(t) represents the second modeled chromatogram, t_{Cx} and s_{Cx} represent the retention times and spatial diffusion coefficients of the first, second, and third gases Cx, and a_{Cx} represent amplitudes of the first, second, and third affine transformed responses

$${\tilde{g}}_{C 1} ( \frac{t - {t}_{Cx}}{{s}_{Cx}} )$$

of the first modeled chromatogram.

A fourteenth embodiment may include any one of the eleventh through thirteenth embodiments, wherein the concentrations of the first, second, and third gases are estimated from corresponding amplitudes of the first, second, and third gas components of the decomposed third chromatogram.

A fifteenth embodiment may include the fourteenth embodiment, wherein the third chromatogram is decomposed using the following mathematical equation:

$${\tilde{f}}_{3} ( t ) = {\sum }_{Cx ∈ G} {f}_{Cx} {\tilde{g}}_{Cx} ( t - Δ t ) + {f}_{0}$$

wherein \tilde{ƒ}₃(t) represents the decomposed third chromatogram, \tilde{g}_{Cx} represent responses of the first, second, and third gases Cx in the second modeled chromatogram, Δt represents a time shift, ƒ₀ represents a detector response shift, ƒ_{Cx} represent amplitudes of the first, second, and third gas components.

In a sixteenth embodiment, a method for calibrating a gas chromatography (GC) apparatus for estimating a composition of an unknown gas sample including at least first, second, and third gases comprises measuring first and second chromatograms of corresponding first and second calibration samples using the GC apparatus, the first calibration sample including the first gas and the second calibration sample including the first, second, and third gases; fitting the first chromatogram with a basis function derived from a mass balance equation to obtain a first modeled chromatogram; fitting the second chromatogram with first, second, and third affine transformed responses of the first modeled chromatogram to obtain a second modeled chromatogram, the first, second, and third affine transformed responses corresponding to the first, second, and third gases; and generating first, second, and third linear correlations between corresponding amplitudes of the first, second, and third affine transformed responses of the first modeled chromatogram and concentrations of the first, second, and third gases.

A seventeenth embodiment may include the sixteenth embodiment, wherein the first calibration sample comprises a negligible concentration of the second and third gases.

An eighteenth embodiment may include any one of the sixteenth through seventeenth embodiments, wherein the first calibration sample comprises methane; and the second calibration sample comprises methane, ethane, propane, butane, and pentane.

A nineteenth embodiment may include any one of the sixteenth through eighteenth embodiments, wherein the first modeled chromatogram comprises a first set of calibration parameters including a retention time, a spatial diffusion coefficient, and a decay rate of the first gas in the GC apparatus; and the second modeled chromatogram comprises a second set of calibration parameters including a retention time and a spatial diffusion coefficient for each of the first, second, and third gases, and an amplitude for each of the first, second, and third affine transformed responses of the first modeled chromatogram.

A twentieth embodiment may include the nineteenth embodiment, wherein the first chromatogram is fit using the following mathematical equation:

$${\tilde{g}}_{C 1} ( t ) = {\sum }_{m = 1}^{M} {a}_{m} {g}_{M B E} ( t , {θ}_{m} )$$

wherein \tilde{g}_{C1}(t) represents the first modeled chromatogram, aₘ represents an amplitude, and g_{MBE}(t,θₘ) represents the basis function, wherein:

$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t )$$

wherein H(t) represents the Heaviside step function and θₘ=(tₘ,sₘ,pₘ) in which tₘ represents the retention time of the first gas in the GC apparatus, sₘ represents the spatial diffusion coefficient of the first gas in the GC apparatus, and pₘ represents the decay rate of the first gas in the GC apparatus; and
the second chromatogram is fit using the following mathematical equation:

$${\tilde{f}}_{2} ( t ) = {\sum }_{Cx ∈ G} {a}_{Cx} {\tilde{g}}_{C 1} ( \frac{t - {t}_{Cx}}{{s}_{Cx}} ) + {a}_{0}$$

wherein \tilde{ƒ}₂(t) represents the second modeled chromatogram, t_{Cx} and s_{Cx} represent the retention times and spatial diffusion coefficients of the first, second, and third gases Cx, and a_{Cx} represent amplitudes of the first, second, and third affine transformed responses

$${\tilde{g}}_{C 1} ( \frac{t - {t}_{C x}}{{s}_{Cx}} )$$

of the first modeled chromatogram.

Although chromatogram decomposition and corresponding calibration has been described in detail, it should be understood that various changes, substitutions and alternations can be made herein without departing from the spirit and scope of the disclosure as defined by the appended claims.

What is claimed is:

1. A method for estimating a composition of an unknown gas sample including first, second, and third gases, the method comprising:
calibrating a gas chromatography (GC) apparatus using first and second calibration samples in which the first calibration sample includes the first gas and the second calibration sample includes the first, second, and third gases, the calibrating comprising:
measuring first and second chromatograms of the corresponding first and second calibration samples using the GC apparatus;
fitting the first chromatogram with a basis function derived from a mass balance equation to obtain a first modeled chromatogram; and
fitting the second chromatogram with first, second, and third affine transformed responses of the first modeled chromatogram to obtain a second modeled chromatogram, the first, second, and third affine transformed responses corresponding to the first, second, and third gases;
measuring a third chromatogram of the unknown gas sample using the GC apparatus;
decomposing the third chromatogram into components corresponding to the first, second, and third gases using the second modeled chromatogram; and
estimating concentrations of the first, second, and third gases from the first, second, and third gas components of the decomposed third chromatogram.

2. The method of claim 1, wherein the basis function is asymmetric with respect to retention time.

3. The method of claim 1, wherein the first calibration sample comprises a negligible concentration of the second and third gases.

4. The method of claim 1, wherein the unknown gas sample comprises at least methane, ethane, propane, butane, and pentane.

5. The method of claim 1, wherein:
the first modeled chromatogram comprises a first set of calibration parameters including a retention time, a spatial diffusion coefficient, and a decay rate of the first gas in the GC apparatus; and
the second modeled chromatogram comprises a second set of calibration parameters including a retention time and a spatial diffusion coefficient for each of the first, second, and third gases, and an amplitude for each of the first, second, and third affine transformed responses of the first modeled chromatogram.

6. The method of claim 5, wherein the first chromatogram is fit using the following mathematical equation:
$${\tilde{g}}_{C 1} ( t ) = {\sum }_{m = 1}^{M} {a}_{m} {g}_{M B E} ( t , {θ}_{m} )$$
wherein \tilde{g}_{C1}(t) represents the first modeled chromatogram, aₘ represents an amplitude, and g_{MBE}(t,θₘ) represents the basis function, wherein:
$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t )$$
wherein H(t) represents the Heaviside step function and θₘ=(tₘ,sₘ,pₘ) in which tₘ represents the retention time of the first gas in the GC apparatus, sₘ represents the spatial diffusion coefficient of the first gas in the GC apparatus, and pₘ represents the decay rate of the first gas in the GC apparatus.

7. The method of claim 6, wherein the second chromatogram is fit using the following mathematical equation:
$${\tilde{f}}_{2} ( t ) = {\sum }_{C x ∈ G} {a}_{C x} {\tilde{g}}_{C 1} ( \frac{t - {t}_{Cx}}{{s}_{Cx}} ) + {a}_{0}$$
wherein \tilde{ƒ}₂(t) represents the second modeled chromatogram, t_{Cx} and s_{Cx} represent the retention times and spatial diffusion coefficients of the first, second, and third gases Cx, and a_{Cx} represent the amplitudes of the first, second, and third affine transformed responses
$${\tilde{g}}_{C 1} ( \frac{t - {t}_{C x}}{{s}_{Cx}} )$$
of the first modeled chromatogram.

8. The method of claim 1, wherein the concentrations of the first, second, and third gases are estimated from corresponding amplitudes of the first, second, and third gas components of the decomposed third chromatogram.

9. The method of claim 8, wherein the third chromatogram is decomposed using the following mathematical equation:
$${\tilde{f}}_{3} ( t ) = {\sum }_{C x ∈ G} {f}_{Cx} {\tilde{g}}_{Cx} ( t - Δ t ) + {f}_{0}$$
wherein \tilde{ƒ}₃(t) represents the decomposed third chromatogram, \tilde{g}_{Cx} represent responses of the first, second, and third gases Cx in the second modeled chromatogram, Δt represents a time shift, ƒ₀ represents a detector response shift, ƒ_{Cx} represent amplitudes of the first, second, and third gas components.

10. The method of claim 8, wherein the calibrating the gas chromatography (GC) apparatus further comprises generating first, second, and third linear correlations between corresponding amplitudes of the first, second, and third affine transformed responses of the first modeled chromatogram and concentrations of the first, second, and third gases.

11. A system for estimating a composition of an unknown gas sample including first, second, and third gases, the system comprising:
a gas chromatography (GC) apparatus including a sample injection port, a main column, and a GC detector; and
a processor configured to:
fit a first chromatogram with a basis function derived from a mass balance equation to compute a first modeled chromatogram, the first chromatogram measured using a first calibration sample including the first gas;
fit a second chromatogram with first, second, and third affine transformed responses of the first modeled chromatogram to compute a second modeled chromatogram, the second chromatogram measured using a second calibration sample including the first, second, and third gases, the first, second, and third affine transformed responses corresponding to the first, second, and third gases;
decompose a third chromatogram into first, second, and third gas components using the second modeled chromatogram, the third chromatogram measured using the unknown gas sample; and
estimate concentrations of the first, second, and third gases from the first, second, and third gas components of the decomposed third chromatogram.

12. The system of claim 11, wherein the first chromatogram is fit using the following mathematical equation:
$${\tilde{g}}_{C 1} ( t ) = {\sum }_{m = 1}^{M} {a}_{m} {g}_{M B E} ( t , {θ}_{m} )$$
wherein \tilde{g}_{C1}(t) represents the first modeled chromatogram, aₘ represents an amplitude, and g_{MBE}(t,θₘ) represents the basis function, wherein:
$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t )$$
wherein H(t) represents the Heaviside step function and θₘ=(tₘ,sₘ,pₘ) in which tₘ represents the retention time of the first gas in the GC apparatus, sₘ represents the spatial diffusion coefficient of the first gas in the GC apparatus, and pₘ represents the decay rate of the first gas in the GC apparatus.

13. The system of claim 12, wherein the second chromatogram is fit using the following mathematical equation:
$${\tilde{f}}_{2} ( t ) = {\sum }_{C x ∈ G} {a}_{C x} {\tilde{g}}_{C 1} ( \frac{t - {t}_{Cx}}{{s}_{Cx}} ) + {a}_{0}$$
wherein \tilde{ƒ}₂(t) represents the second modeled chromatogram, t_{Cx} and s_{Cx} represent the retention times and spatial diffusion coefficients of the first, second, and third gases Cx, and a_{Cx} represent amplitudes of the first, second, and third affine transformed responses
$${\tilde{g}}_{C 1} ( \frac{t - {t}_{C x}}{{s}_{Cx}} )$$
of the first modeled chromatogram.

14. The system of claim 11, wherein the concentrations of the first, second, and third gases are estimated from corresponding amplitudes of the first, second, and third gas components of the decomposed third chromatogram.

15. The system of claim 14, wherein the third chromatogram is decomposed using the following mathematical equation:
$${\tilde{f}}_{3} ( t ) = {\sum }_{C x ∈ G} {f}_{Cx} {\tilde{g}}_{Cx} ( t - Δ t ) + {f}_{0}$$
wherein \tilde{ƒ}₃(t) represents the decomposed third chromatogram, \tilde{g}_{Cx} represent responses of the first, second, and third gases Cx in the second modeled chromatogram, Δt represents a time shift, ƒ₀ represents a detector response shift, ƒ_{Cx} represent amplitudes of the first, second, and third gas components.

16. A method for calibrating a gas chromatography (GC) apparatus for estimating a composition of an unknown gas sample including first, second, and third gases, the method comprising:
measuring first and second chromatograms of corresponding first and second calibration samples using the GC apparatus, the first calibration sample including the first gas and the second calibration sample including the first, second, and third gases;
fitting the first chromatogram with a basis function derived from a mass balance equation to obtain a first modeled chromatogram;
fitting the second chromatogram with first, second, and third affine transformed responses of the first modeled chromatogram to obtain a second modeled chromatogram, the first, second, and third affine transformed responses corresponding to the first, second, and third gases; and
generating first, second, and third linear correlations between corresponding amplitudes of the first, second, and third affine transformed responses of the first modeled chromatogram and concentrations of the first, second, and third gases.

17. The method of claim 16, wherein the first calibration sample comprises a negligible concentration of the second and third gases.

18. The method of claim 16, wherein:
the first calibration sample comprises methane; and
the second calibration sample comprises methane, ethane, propane, butane, and pentane.

19. The method of claim 16, wherein:
the first modeled chromatogram comprises a first set of calibration parameters including a retention time, a spatial diffusion coefficient, and a decay rate of the first gas in the GC apparatus; and
the second modeled chromatogram comprises a second set of calibration parameters including a retention time and a spatial diffusion coefficient for each of the first, second, and third gases, and an amplitude for each of the first, second, and third affine transformed responses of the first modeled chromatogram.

20. The method of claim 19, wherein:
the first chromatogram is fit using the following mathematical equation:
$${\tilde{g}}_{C 1} ( t ) = {\sum }_{m = 1}^{M} {a}_{m} {g}_{M B E} ( t , {θ}_{m} )$$
wherein \tilde{g}_{C1}(t) represents the first modeled chromatogram, aₘ represents an amplitude, and g_{MBE}(t,θₘ) represents the basis function, wherein:
$${g}_{M B E} ( t , {θ}_{m} ) = {t}^{- ( {p}_{m} / 2 )} exp ( \frac{{( t - {t}_{m} )}^{2}}{2 {s}_{m} t} ) H ( t )$$
wherein H(t) represents the Heaviside step function and θₘ=(tₘ,sₘ,pₘ) in which tₘ represents the retention time of the first gas in the GC apparatus, sₘ represents the spatial diffusion coefficient of the first gas in the GC apparatus, and pₘ represents the decay rate of the first gas in the GC apparatus; and
the second chromatogram is fit using the following mathematical equation:
$${\tilde{f}}_{2} ( t ) = {\sum }_{C x ∈ G} {a}_{C x} {\tilde{g}}_{C 1} ( \frac{t - {t}_{Cx}}{{s}_{Cx}} ) + {a}_{0}$$
wherein \tilde{ƒ}₂(t) represents the second modeled chromatogram, t_{Cx} and s_{Cx} represent the retention times and spatial diffusion coefficients of the first, second, and third gases Cx, and a_{Cx} represent amplitudes of the first, second, and third affine transformed responses
$${\tilde{g}}_{C 1} ( \frac{t - {t}_{C x}}{{s}_{Cx}} )$$
of the first modeled chromatogram.
